(19) United States
(12) Patent Application Publication
(10) Pub. No.: US 2007/0131078 A1
(43) Pub. Date: Jun. 14, 2007

(54) Real-time digital phase and gain adaptation method using feedback and arrangement using such a method

(76) Inventor: Andre Kokkeler, Hb Borne (NL)

Correspondence Address: ERICSSON INC., 6300 LEGACY DRIVE, M/S EVR 1-C-11, PLANO, TX, 75024, US

(21) Appl. No.: 10/535,904

(22) PCT Filed: Nov. 22, 2002
(86) PCT No.: PCT/NL02/00757

§ 371 Date: Jan. 4, 2006

(51) Int. Cl. G10H 3/18

(52) U.S. Cl. 84/1

(57) ABSTRACT

Arrangement for real-time phase and gain adaptation as a function of frequency and gain adaptation as a function of amplitude of an input signal in relation to an output signal, the input signal having a first absolute phase and first power as a function of frequency, the output signal having a second absolute phase and second power as a function of frequency, the output signal, in use, being amplified relative to the input signal, the arrangement including a gain correction, and a power amplifier, the gain correction being arranged for receiving the input signal at a third input and a gain reference signal at the second input and for correcting the first power of the input signal, relative to the second power of the output signal, to form a predistorted outgoing signal and for outputting at the first output the predistorted outgoing signal, the gain reference signal having a gain value identical to the second power of the output signal relative to the first power of the input signal, wherein the arrangement includes a phase correction arranged for receiving the input signal at a third input and a phase reference signal at the second input and for correcting the first absolute phase of the input signal, relative to the second absolute phase of the output signal, as a function of frequency to form a phase-corrected outgoing signal and for outputting at the first output the phase-corrected outgoing signal, the phase reference signal having a phase value identical to the second absolute phase of the output signal relative to the first absolute phase of the input signal, the gain correction and the phase correction using a single feedback signal in the feedback path for deriving the gain reference signal and the phase reference signal, respectively.

### FIELD OF THE INVENTION

The present invention relates to an arrangement of real-time digital phase and gain adaptation according to the preamble of claim 1. Also, the present invention relates to a method according to the preamble of claim 9.

### PRIOR ART

Such a system and method are known in areas in which a combination of analogue and digital components, subsystems or systems are used with a digital input signal and an analogue output signal and where the bandwidth is relatively large. An important example of an application using such a system and method is the third generation wireless telephony system UMTS (Universal Mobile Telecommunications System).

Within many electronic systems for telecommunication, the performance of such a system is limited by the non-linear behaviour of Digital to Analogue Converters (DAC) and Analogue to Digital Converters (ADC), analogue components, analogue systems and subsystems. There are several effects of this non-linear behaviour:

the relation between an input amplitude (or envelope) and an output amplitude (or envelope) is not linear,

the phase relation between the absolute phase of the input signal and the absolute phase of the output signal of a system varies as a function of frequency (frequency-dependent phase),

the overall gain (i.e., the power of the output signal relative to the power of the input signal) varies as a function of frequency (frequency-dependent gain).

In the remainder of this document the non-linear relation between an input amplitude (or envelope) and an output amplitude (or envelope) will be referred to as “gain as a function of amplitude”. Real-time adaptation of the gain as a function of amplitude when applied to amplifiers is widely known as “digital predistortion”. It is used to compensate the non-linear transfer function of (power) amplifiers.

Determining the phase and gain as a function of frequency is currently mainly based on careful selection and design of the analogue parts of a system. Furthermore, equalisation techniques are used to compensate for the non-uniform gain-frequency relation of transmission media.

In many applications of electronic systems for (tele-)communication, active control over especially the phase behaviour as a function of frequency is very important. For example, in beam forming with an antenna array comprising an assembly of several antennas, the direction in which the antenna array transmits and receives energy is steered by the control over the relative phase of the signal at each individual antenna. A frequency-dependent phase shift is necessary to properly steer beams at all relevant frequencies.

Frequency-dependent phase shift for phase adaptation may be used on various component levels in relation to e.g., calibration of antenna arrays in broadband systems, and linearisation (of phase and amplitude as a function of frequency) of analogue components.

Methods exist for calibration of the total power (power integrated over frequency) and average phase (phase averaged over frequency) in real-time. In all these methods, a dedicated feedback loop is used to measure the total power and the average phase of the output signal. For narrow-band systems, this solution may be sufficient, but for broad-band systems, such as UMTS, especially frequency-dependent phase deviations may still be significant.

An important application of Real-time Frequency-Dependent phase and gain calibration is within the area of antenna array transmitters, used in beam forming applications. Side-lobe distortion of the beam is the driving concern for most antenna array systems. This distortion is mainly caused by deviations from the ideal case of the phase of the signals transmitted at the individual array elements (antennas).

For narrow-band systems, phase-related deviations of signals are assumed to be constant over the entire frequency band.

For broad-band systems, such as Wide-band Code Division Multiple Access (WCDMA) systems, the phase deviations vary for different frequencies. The frequency dependent deviations typically measured within WCDMA systems, not using phase calibration, can be determined and are found to be typically ±9°, due to Saw Filter ripple and low Voltage Standing Wave Ratio (VSWR) terminations of the feeder cable. As known to persons skilled in the art, it can be shown that this deviation would lead to array average side-lobes, which are about 10 dB below the isotropic radiation pattern of the antenna array.

It has been indicated in Candidate Calibration Architectures for Use in URTRA Adaptive Antenna Base-stations, K. A. Morris, C. M. Simmonds and M. A. Beach, in: Advanced Communications Technologies and Services (ACTS) 1999, that the typical phase matching needed within adaptive antenna systems equals 3°, which yields an array average side-lobe level of −20 dB. Thus, for sufficient reduction of side-lobe distortion, the frequency-dependent phase deviation has to be reduced from ±9° to ±3°.

In prior art system it is not possible to change the gain and phase as a function of frequency in real-time without, disadvantageously, interrupting the normal data-flow of input and output signals maintained by the electronic system.

In other prior art systems where only the total power and/or the average phase are calibrated (without interruption of normal data flow), disadvantageously the pointing accuracy of a beam forming system, such as an antenna array, is limited and, therefore, more energy is used than needed in case of correct calibration, to guarantee a certain quality for the users. Furthermore, the side-lobe levels in the beam broadcasted by the antenna array are higher, increasing the overall interference levels (between various antenna arrays within a network and also single antenna systems (e.g. mobile phones) within a network), reducing overall system capacity.

### SUMMARY OF THE INVENTION

In the present invention it is recognised that real-time adaptation of the frequency-dependent phase and gain is required to improve the beam forming.

It is an object of the present invention to provide an arrangement as defined in the preamble of claim 1 that is capable of correcting gain as a function of amplitude and of correcting frequency-dependent gain and phase for any type of device with a digital input signal and analogue output signal.

The present invention relates to an arrangement as defined in the preamble of claim 1, characterised in that
the arrangement comprises a phase correction block, the phase correction block being connected at a third input for receiving the input signal,
the phase correction block being connected in the feedback path to the input of the power amplifier through a first output of the phase correction block, and a through a second input of the phase correction block to the output of the power amplifier;
the phase correction block being arranged for receiving the input signal at a third input and a phase reference signal at the second input and for correcting the first absolute phase of the input signal, relative to the second absolute phase of the output signal, as a function of frequency to form a phase-corrected outgoing signal and for outputting at the first output the phase-corrected outgoing signal, the phase reference signal having a phase value identical to the second absolute phase of the output signal relative to the first absolute phase of the input signal,
the gain correction block and the phase correction block using a single feedback signal in the feedback path for deriving the gain reference signal and the phase reference signal, respectively.

The arrangement according to the present invention achieves that the predistortion of the input signal is such that the output signal transmitted at the antenna is to be substantially undistorted relative to the input signal.

Advantageously, this arrangement allows the real-time adaptation of phase and gain as a function of frequency without interrupting the normal data-flow of input and output signals.

Moreover, the present invention relates to a method as defined in the preamble of claim 9, characterised in that
the method comprises a phase correction;
the phase correction comprising:
   receiving the input signal and a phase reference signal from the feedback path,
   correcting the first absolute phase of the input signal, relative to the second absolute phase of the output signal, as a function of frequency into a phase-corrected outgoing signal, and
   outputting the phase-corrected outgoing signal, the phase reference signal having a phase value identical to the second absolute phase of the output signal relative to the first absolute phase of the input signal,
      wherein the gain correction and the phase correction are using a single feedback signal in the feedback path for deriving the gain reference signal and the phase reference signal, respectively.

Furthermore, the present invention relates to a computer program product, as defined in the preamble of claim 10
characterised in that
the computer program further allows the arrangement to carry out a phase correction;
the phase correction comprising:
   receiving the input signal and a phase reference signal from the feedback path,
   correcting the first absolute phase of the input signal, relative to the second absolute phase of the output signal, as a function of frequency into a phase-corrected outgoing signal, and
   outputting the phase-corrected outgoing signal, the phase reference signal having a phase value identical to the second absolute phase of the output signal relative to the first absolute phase of the input signal,
      wherein the gain correction and the phase correction are using a single feedback signal in the feedback path for deriving the gain reference signal and the phase reference signal, respectively.
      Also, the present invention relates to a data carrier with a computer program product as defined above.

### BRIEF DESCRIPTION OF DRAWINGS

Below, the invention will be explained with reference to some drawings, which are intended for illustration purposes only and not to limit the scope of protection which is defined in the accompanying claims.

FIG. 1 shows a block diagram for digital predistortion of a power amplifier in a transmitter according to the prior art;

FIG. 2 shows a block diagram for frequency-dependent phase calibration of an antenna transmitter according to the prior art;

FIG. 3 shows a block diagram for digital predistortion of a power amplifier and phase calibration in a transmitter according to the present invention;

FIG. 4 shows a detailed block diagram for real-time phase adaptation and phase estimation of a power amplifier in a transmitter according to the present invention;

FIG. 5 shows a block diagram of a generalised adaptation and estimation scheme for a system in accordance with the present invention.

### DESCRIPTION OF PREFERRED EMBODIMENTS

In the following description, the present invention will be described with reference to a transmitter (e.g., an antenna array). It is noted that the principles disclosed here to design a transmitter with digital predistortion and phase calibration can be generalised to a method for correction of gain as a function of amplitude, delay and frequency-dependent gain and phase for any type of device with a digital input signal and an analogue output signal.

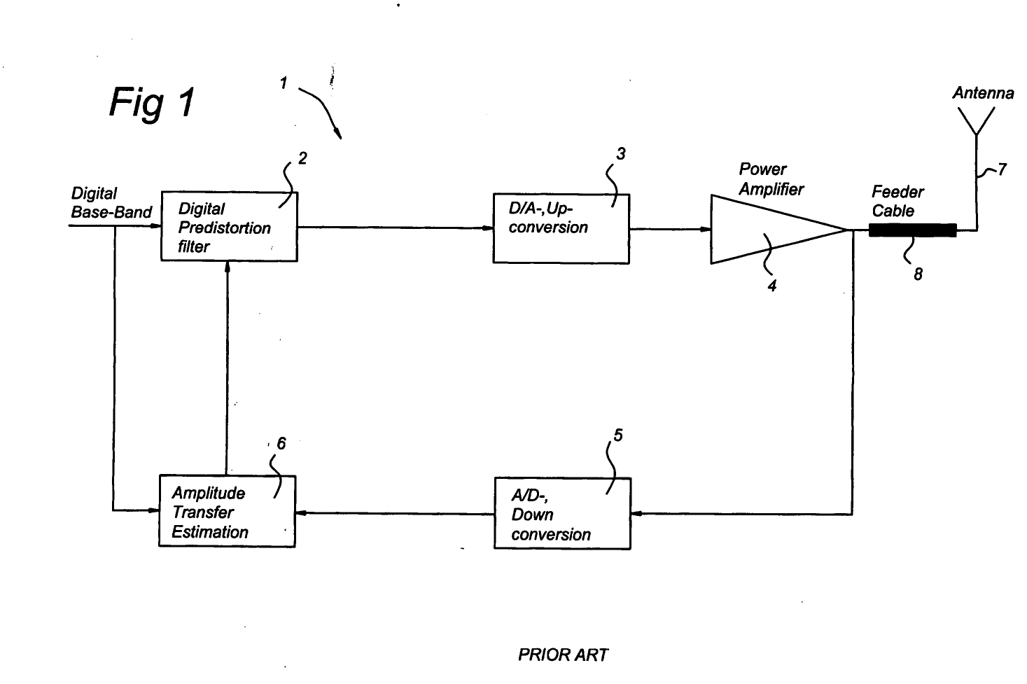

FIG. 1 shows a block diagram for digital predistortion of a power amplifier in a transmitter according to the prior art.

A transmitting antenna array generally exists of multiple, functionally identical transmitters. A block diagram of a typical transmitter according to the prior art and including a digital predistortion device for the power amplifier, is given in FIG. 1.

A transmitter 1 comprises a digital predistortion block 2, digital-analogue converter and up-converter 3, a power amplifier 4, analogue-digital converter and down-converter 5, an amplitude transfer estimation block 6, an antenna 7 and feeder-cable 8.

The digital predistortion block 2 comprises a first input for entry of digital base-band signals. An output of digital predistortion block 2 is connected to an input of digital-analogue converter and up-converter 3. An output of digital-analogue converter and up-converter 3 is connected to an input of power amplifier 4. An output of power amplifier 4 is connected to an input of analogue-digital converter and down-converter 5. An output of analogue-digital converter and down-converter 5 is connected to a first input of amplitude transfer estimation block 6. An output of amplitude transfer estimation block 6 is connected to a second input of digital predistortion block 2.

The power amplifier 4 is further connected at it's output to antenna 7 by means of feeder-cable 8.

The digital base-band signal to be transmitted by the transmitter is input at the first input of the digital predistortion block 2, and also at a second input of the amplitude transfer estimation block 6. The digital predistortion block 2 and power amplifier process the signals digitally. The digital-analogue converter and up-converter 3 converts the digital signals into analogue signals that can be transmitted by the antenna 7.

The predistortion mechanism corrects the gain as a function of amplitude, which results in a linearisation of the power amplifier 4. However, this prior art system does not have a facility to correct frequency-dependent phase deviations.

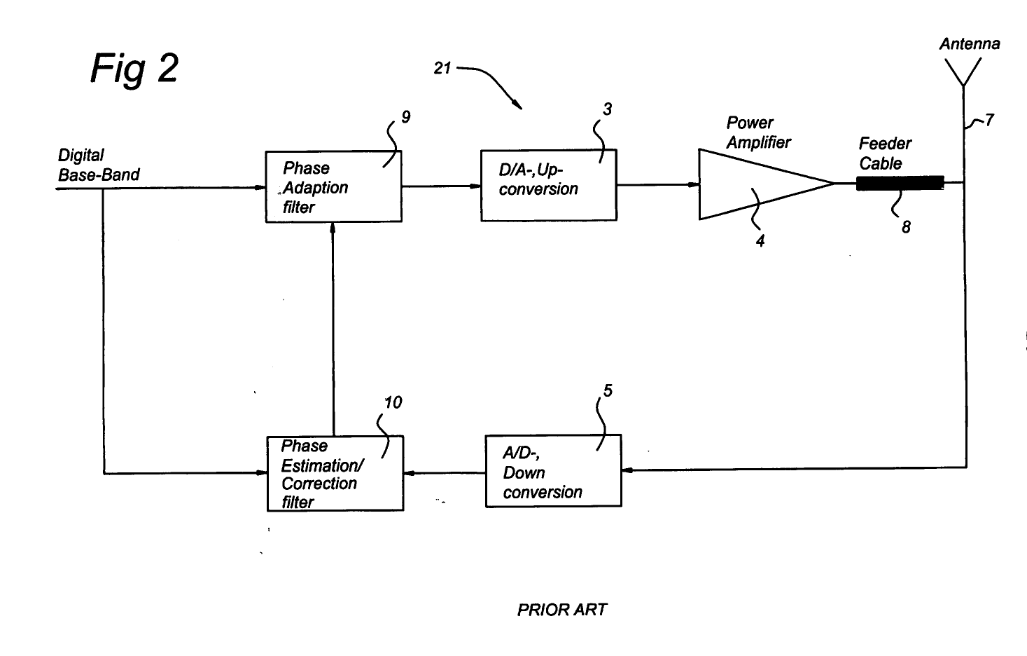

FIG. 2 shows a block diagram for calibration of an antenna transmitter according to the prior art.

Again, a block diagram of a typical transmitter is used to explain the calibration of an antenna transmitter. FIG. 2 shows a second transmitter 21 including a calibration device for the frequency-dependent phase calibration. In FIG. 2, items with the same reference numbers refer to the same items as shown in FIG. 1.

The second transmitter 21 comprises a phase adaptation block 9, digital-analogue converter and up-converter 3, power amplifier 4, analogue-digital converter and down-converter 5, a phase estimation and correction block 10, antenna 7 and feeder-cable 8.

The phase adaptation block 9 comprises a first input for entry of digital base-band signals. An output of phase adaptation block 9 is connected to an input of digital-analogue converter and up-converter 3. An output of digital-analogue converter and up-converter 3 is connected to an input of power amplifier 4. An output of power amplifier 4 is connected to the feeder cable 8 which provides a further connection to the antenna 7. On the side of the antenna 7, a connection is provided to an input of analogue-digital converter and down-converter 5. An output of analogue-digital converter and down-converter 5 is connected to a first input of phase estimation and correction block 10. An output of phase estimation and correction block 10 is connected to a second input of phase adaptation block 9.

The digital base-band signal to be transmitted by the transmitter is input at the first input of the phase adaptation block 9, and also at a second input of the phase estimation and correction block 10. Similar to the predistortion block 2, the phase adaptation block 9 and phase estimation and correction block 10 process signals in the digital domain, while the signal transmitted by the antenna 7 is analogue.

Within the system shown in FIG. 2, the signals are sampled by block 5 at the antenna 7, after passage through the feeder cable 8. The calibration scheme does not linearise the power amplifier 4.

Correction applied to the input signal is frequency-dependent.

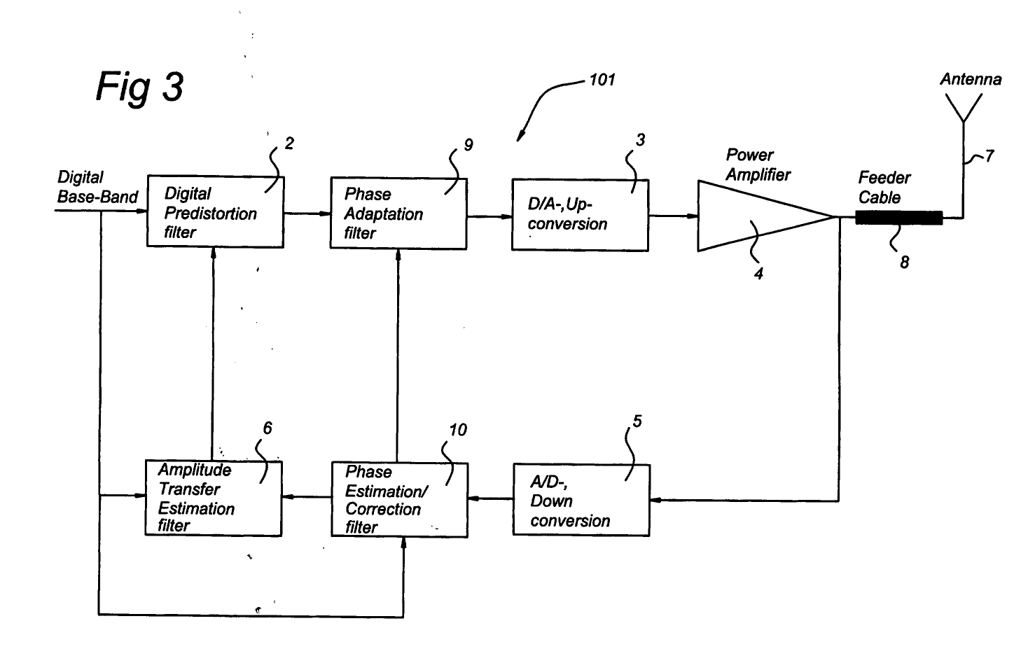

To obtain real-time digital phase and gain adaptation of signals by using feedback, a straightforward combination of the schemes as shown in FIGS. 1 and 2 would result in the use of two separate feedback paths: one used for digital predistortion, another used for calibration. However, in the present invention it is recognised that the digital predistortion scheme shown in FIG. 1 can be combined with the calibration scheme of FIG. 2 as a new scheme which uses only a single feedback loop and a concatenation of the estimation and correction mechanisms. The resulting system is a transmitter 101 as presented in FIG. 3.

FIG. 3 shows a block diagram for digital predistortion of the power amplifier and phase calibration in the transmitter 101 according to the present invention. In FIG. 3, items with the same reference numbers refer to the same items as shown in FIGS. 1 and 2.

The digital predistortion block 2 comprises a first input for entry of digital base-band signals. An output of digital predistortion block 2 is connected to an input of the phase adaptation block 9. An output of phase adaptation block 9 is connected to an input of digital-analogue converter and up-converter 3. An output of digital-analogue converter and up-converter 3 is connected to an input of power amplifier 4. An output of power amplifier 4 is connected to an input of analogue-digital converter and down-converter 5. An output of analogue-digital converter and down-converter 5 is connected to a first input of the phase estimation and correction block 10. A first output of the phase estimation and correction block 10 is connected to a second input of the phase adaptation block 9. A second output of the phase estimation and correction block 10 is connected to a first input of the amplitude transfer estimation block 6. A first output of the amplitude transfer estimation block 6 is connected to the second input of the pre-distortion block 2.

The power amplifier 4 is further connected at it's output to antenna 7 by means of feeder-cable 8.

The digital base-band signal to be transmitted by the transmitter is input at the first input of the digital predistortion block 2, at a second input of the amplitude transfer estimation block 6 and at a second input of the phase estimation and correction block 10.

The signal to be transmitted by the antenna 7 is sampled by analogue-digital converter and down-converter 5. The sampled signal is fed to the first input of the phase estimation and correction block 10. By comparison with the (original) digital base-band signal, available at the second input of the phase estimation and correction block 10, the sampled signal is used to determine a first control signal that is fed to the second input of the phase adaptation block 9 to adapt the settings of the phase adaptation block 9. Simultaneously, an adapted sampled signal is derived from the sampled signal by the phase estimation and correction block 10 and fed to the first input of the amplitude transfer estimation block 6. By comparison with the digital base-band signal, available at the second input of the amplitude transfer estimation block 6, the adapted sampled signal is used to determine a second control signal that is fed to the second input of the digital predistortion block 2 to adapt the settings of the digital predistortion block 2.

The biggest advantage of this scheme is that only a single feedback path is used for both digital predistortion 2 and phase adaptation (or calibration) 9. It is noted that as an alternative for the scheme shown in FIG. 3, the combination of blocks 9 and 10 and the combination of blocks 2 and 6, may be interchanged. In FIG. 3 the second control signal is derived from the sampled signal after determining the first control signal. In the alternative scheme the determination of the first and second control signal is reversed: the first control signal for phase adaptation is derived after determining the second control signal for predistortion.

A consequence of the scheme shown in FIG. 3 (and it's alternative) is that the feeder cable 8 is not calibrated. The frequency-dependent phase effects of feeder cables are normally small. Delay differences of signals traversing the feeder cable 8 may exist. These delay differences can be measured during installation and be corrected in a prior stage. Alternatively, the feeder cable 8 can be included in the circuit of the present invention by connecting the point between the feeder cable 8 and the antenna 7 to the first input of the phase estimation and correction block 10, similar to the connection scheme as shown in FIG. 2.

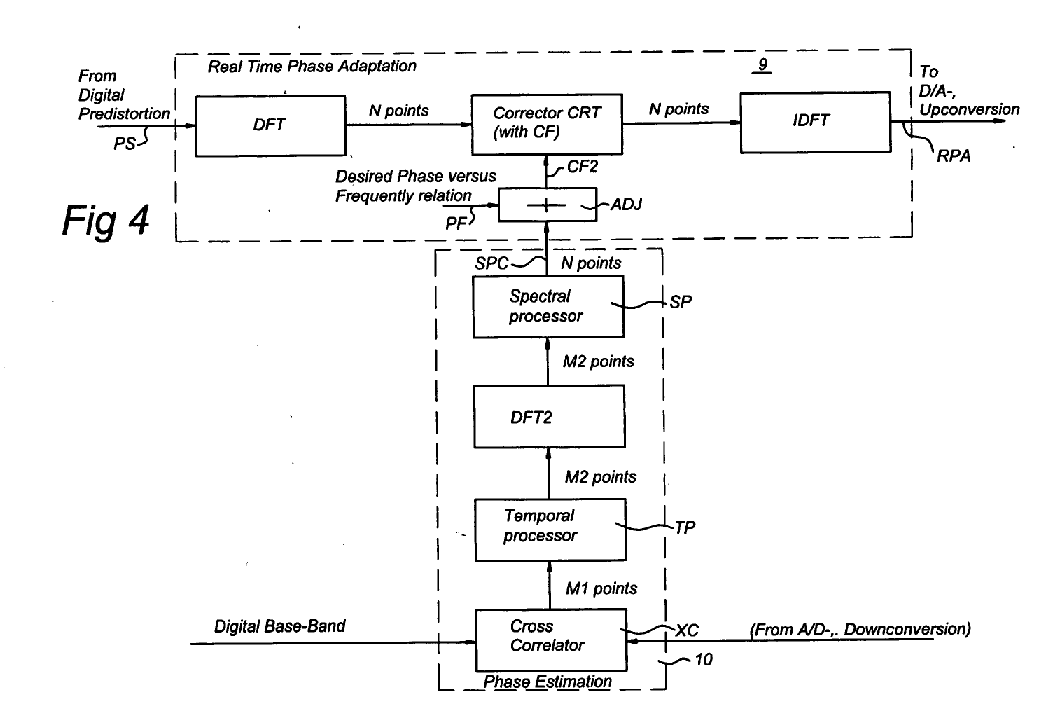

An embodiment of the frequency-dependent phase calibration as represented by the phase adaptation block 9 and the phase estimation and correction block 10 is presented in FIG. 4.

FIG. 4 shows a detailed block diagram for real-time phase adaptation and phase estimation in accordance with the present invention.

The block diagram shown in FIG. 4 is a detailed part of the blocks 9 and 10 of FIG. 3.

The phase adaptation block 9 comprises a first digital Fourier transform processor DFT, a corrector CRT, an inverse digital Fourier transform processor IDFT, and an adjuster ADJ. The digital Fourier transform processor DFT is connected to a first input of corrector CRT. Corrector CRT is connected at an output to an input of the inverse digital Fourier transform processor IDFT. Further, adjuster ADJ is connected with an output to a second input of corrector CRT. The digital Fourier transform processor DFT receives at it's input the predistorted signal PS from the output of the predistortion block 2. The adjuster ADJ receives at a first input a spectral signal SPC from the phase estimation and correction block 10, and at a second input a phase-frequency signal PF representing a desired phase and frequency relation. A real-time phase adapted signal RPA is outputted by the inverse digital Fourier transform processor IDFT and passed on to the input of the digital-analogue converter and up-converter 3. The base-band signal and the signals PS, SPC, PF, and RPA are all in the digital domain.

The phase estimation and correction block 10 comprises a cross-correlator XC, a temporal processor TP, a second digital Fourier transform processor DFT2, and a spectral processor SP. The cross-correlator XC receives on a first input a signal to be transmitted from the digital base-band and on a second input the transmitted signal from the analogue-digital converter and down converter 5. The cross-correlator XC is connected at an output to an input of the temporal processor TP. The temporal processor TP is connected at an output to an input of the second digital Fourier transform processor DFT2. The second digital Fourier transform processor DFT2 is connected at an output to an input of the spectral processor SP. Finally, the spectral processor SP is connected at an output to the first input of the adjuster ADJ.

The predistorted data signal PS from the digital predistortion block 2 is divided into blocks of length N. A digital Fourier transform is executed in the first digital Fourier transform processor DFT using this data to calculate a representation in the frequency domain. Note that if N=2^{k}, with k being a positive integer number, a Fast Fourier Transform algorithm can be used. A phase correction in the corrector CRT, which performs a complex multiplication per frequency point using correction factors CF obtained from the adjuster ADJ, then determines the relative phase for every frequency point (of N points). Then, the inverse digital Fourier transform processor IDFT performs an inverse digital Fourier transform or an inverse fast Fourier transform algorithm (in case N=2^{k}), which transfers the signal from the frequency domain back into the time domain as a real-time phase adapted signal RPA.

The phase estimation and correction block 10 divides both the signal it receives from the feedback path on its second input and the original digital base-band signal (received on its first input) into blocks of data. The cross-correlator XC synchronises and then cross-correlates the two blocks of data into M1 cross correlation points. Different cross-correlation functions can be used, generally subdivided into 2 classes:
1. every point of the correlation function is based on the same amount of data from the first and the second input. Generally, as known to persons skilled in the art, this is not the most efficient implementation of the correlation function,
2. usually, points of the correlation function are based on different amounts of data from the first and second input.

Next, the temporal processor TP performs an algorithm to change the number of points of the correlation function from M1 points to M2 points. For example: an averaging procedure to reduce the number of points and interpolation to increase the number of points. Also, M1 may equal M2.

Next, the second digital Fourier transform processor DFT2 (in case M2=2^{j}, with j being a positive integer, a fast Fourier transform (FFT) can be used) is used to translate the cross correlation function into a power spectrum by an digital Fourier transform or an FFT (in case M2=2^{j}).

Then, the spectral processor SP performs a spectral processing to obtain an estimate of the phase as a function of frequency being represented as an N-point spectral signal SPC. The N-point spectral signal SPC is outputted by the spectral processor SP to the first input of the adjuster ADJ. The adjuster ADJ calculates new correction factors CF2 to obtain the desired phase-frequency-relation (as received on the second input of ADJ). The new correction factors CF2 are then inputted in the corrector CRT to replace former correction factors CF.

According to the present invention, phase errors of an antenna array can be reduced to ±0.2° without disturbing the digital predistortion of the power amplifier 4.

In this embodiment, the phase adaptation block 9 and the phase estimation and correction block 10 are embodied by various computational devices DFT, CRT, IDFT, ADJ, XC, TP, DFT2, and SP. It is noted that, alternatively, several or all of these computational devices may be combined in one or more special-purpose processors. In a further embodiment, phase adaptation block 9 and the phase estimation and correction block 10 may be present as software-modules loaded and executed in one or more processors.

The advantage of using this new scheme which uses only a single feedback loop and a concatenation of the estimation and correction mechanisms as shown in FIGS. 3 and 4, real-time phase and gain adaptation according to the present invention is that no tuning procedures for the hardware, including the power amplifier, are needed during production, installation and lifetime of the product. Further, the phase calibration according to the present invention uses less components than in systems of the prior art. This has positive effects on costs, size of the product, power consumption and reliability.

Implementing frequency-dependent phase adaptation in the digital domain has several advantages. Standard processors and their software libraries accommodate fast implementation, which makes it easy to evaluate several alternative adaptation algorithms for the computational devices DFT, CRT, IDFT, ADJ, XC, TP, DFT2, and SP. Another advantage of implementation in the digital domain is that the system is much less dependent on environmental conditions compared to systems where adaptation is done in the analogue domain.

Because of real-time adaptation, the pointing accuracy of beam forming antenna arrays is increased and the average side-lobe levels are reduced. As a consequence, less energy is used to achieve a guaranteed quality of connections within a wireless system which can be translated into a higher capacity (i.e., in terms of throughput or traffic density).

From the transmission system 101 according to the present invention as described above, a more general system with digital adaptation can be derived and a method to compose such a system.

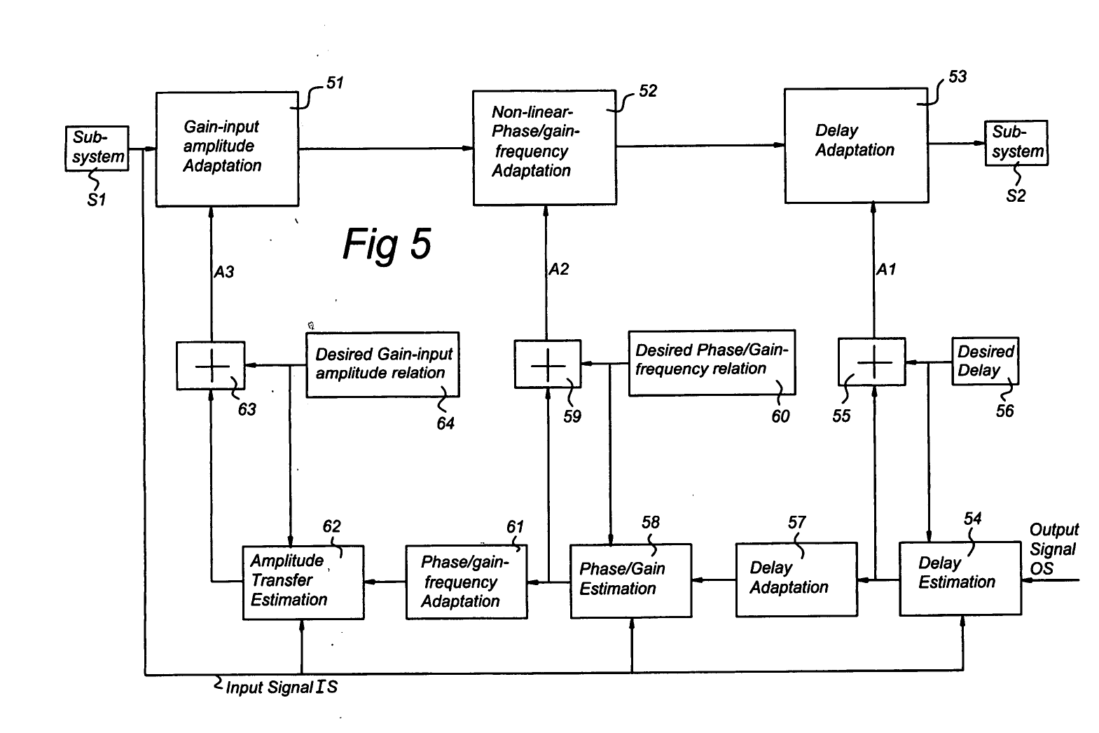

FIG. 5 shows a block diagram of a generalised adaptation and estimation system in accordance with the present invention.

Here it is assumed that the generalised adaptation and estimation system in accordance with the present invention is positioned in between two subsystems, viz. a first subsystem S1 and a second subsystem S2. First subsystem S1 generates an incoming signal to be handled further by second subsystem S2. The generalised adaptation and estimation system according to the present invention is designed to perform a general correction of gain as a function of amplitude, delay, phase as a function of frequency and gain as a function of frequency on the signal originated in first subsystem S1 before passing the signal on to subsystem S2.

Such a generalised adaptation and estimation system comprises a gain-input amplitude adaptation device 51, a non-linear phase and gain-frequency adaptation device 52, a first delay adaptation device 53, a delay estimation device 54, a delay adjuster 55, a second delay adaptation device 57, a phase and gain estimation device 58, a phase and gain adjuster 59, a phase and gain frequency adaptation device 61, an amplitude transfer estimation device 62, and a gain adjuster 63.

Gain-input amplitude adaptation device 51 is connected at an output to a first input of non-linear phase and gain-frequency adaptation device 52. Further, an input of gain-input amplitude adaptation device 51 is connected to an output of first subsystem S1 to receive signals from subsystem SI over incoming signal path IS.

Non-linear phase and gain-frequency adaptation device 52 is connected at an output to a first input of first delay adaptation device 53.

First delay adaptation device 53 is connected at an output to second subsystem S2.

Delay estimation device 54 is connected at a first input to a feedback signal from the second subsystem S2 over output signal feedback path OS. Also, delay estimation device 54 is connected at a second input to the signal originated in the first subsystem SI over incoming signal path IS. Further, delay estimation device 54 is connected at a third input to a signal which represents the desired delay 56. Finally, delay estimation device 54 is connected at an output to an input of delay adjuster 55 and an input of second delay adaptation device 57.

Delay adjuster 55 is further connected at a second input to the signal representing the desired delay 56. At its output, delay adjuster 55 is connected to a second input of delay adaptation device 53 for sending a delay-related adaptation input signal A1.

Second delay adaptation device 57 is at its output connected to a first input of phase and gain estimation device 58.

Phase and gain estimation device 58 is connected at a second input to the signal originated in the first subsystem S1 over incoming signal path IS. Further, phase and gain estimation device 58 is connected at a third input to a signal which represents the desired phase and gain as a function of frequency 60. Finally, phase and gain estimation device 58 is connected at an output to an input of phase and gain adjuster 59 and an input of phase and gain frequency adaptation device 61.

Phase and gain adjuster 59 is further connected at a second input to the signal representing the phase/gain frequency relation. At its output, phase and gain adjuster 59 is connected to a second input of non-linear phase and gain-frequency adaptation device 52 for sending a phase- and gain-related adaptation input signal A2.

Phase and gain frequency adaptation device 61 is at its output connected to a first input of amplitude transfer estimation device 62.

Amplitude transfer estimation device 62 is connected at a second input to the signal originated in the first subsystem S1 over incoming signal path IS. Further, amplitude transfer estimation device 62 is connected at a third input to a signal which represents the desired gain-input amplitude relation 64. Finally, amplitude transfer estimation device 62 is connected at an output to an input of gain adjuster 63.

Gain adjuster 63 is further connected at a second input to the signal which represents the desired gain amplitude relation 64. At its output, gain adjuster 63 is connected to a second input of gain amplitude adaptation device 51 for sending a gain-input amplitude-related adaptation input signal A3.

The purpose of the scheme shown in FIG. 5 is to modify any subset of the 4 possible relations (gain as a non-linear function of frequency, phase as a non-linear function of frequency, delay( i.e., linear “gain as a function of frequency and phase as a function of frequency”-adaptation) and gain as a function of amplitude) of second subsystem S2. Second subsystem S2 has a digital input and an analogue output, is preceded by first subsystem S1 (although not necessarily) and (possibly) followed by at least one further subsystem S3.

In order to enable the adaptation of a subset of relations, 3 functional blocks are added: a real-time adaptation block (51, 52, 53), a feedback path (OS) and a parameter estimation block (54, 55, 56, 57, 58, 59, 60, 61, 62, 63 and 64). To adapt the relations, the incoming signal is modified digitally by the real-time adaptation block (51, 52, 53). The modified data is then transferred through second subsystem S2, possibly sent to a further subsystem S3 and transferred through a feedback path OS to the parameter estimation block (54, 55, 56, 57, 58, 59, 60, 61, 62, 63 and 64). The parameter estimation block (54, 55, 56, 57, 58, 59, 60, 61, 62, 63 and 64) compares the original incoming signal over incoming signal path IS with the output signal received over output signal feedback path OS, determines the characteristics of the relations mentioned and determines the parameters for the real-time adaptation in the real-time adaptation block (51, 52, 53).

Two different sets of relations can be identified: a first set is based on gain as a function of amplitude and a second set is based on phase as a function of frequency and gain as a function of frequency. It is noted that delay of signals causes a linear phase deviation as a function of frequency. The real-time adaptation block (51, 52, 53) and the parameter estimation blocks (54, 55, 56, 57, 58, 59, 60, 61, 62, 63 and 64) deal with these sets of relations in a separate manner.

The real-time adaptation block is split into a “gain as function of amplitude”-adaptation and “phase as a function of frequency and gain as a function of frequency” adaptation, where the adaptation by “phase as a function of frequency and gain as a function of frequency” is split into a non-linear part and a linear part. The non-linear part relates to non-linear “phase as a function of frequency and gain as a function of frequency” adaptation. The linear part relates to a linear “phase as a function of frequency and gain as a function of frequency” adaptation, i.e., a delay adaptation.

The estimation process is split as well but the order in which the parameters are estimated is reversed: first the delay is determined, then the phase and gain as a function of frequency is determined, and finally, the gain as a function of amplitude is determined. In order to execute the latter estimation correctly, phase and gain adaptation has to be applied to the data on the feedback path OS before input to “gain as function of amplitude”-adaptation.

The order of the adaptations can be changed in dependence of the stability of the system and practical implementation issues. Consequently, then, the order in which the relations are estimated must be reversed as well.

It is noted that in some cases the delay adaptation may be omitted: then only the “gain as function of amplitude”-adaptation and non-linear “phase as a function of frequency and gain as a function of frequency”-adaptation and their corresponding estimation block need to be implemented.

Also, the same principle can be used to split the phase and gain estimation and adaptation processes further in more additional frequency-related components. Once again, the order in which the adaptations may be executed can be chosen as desired.

It is further noted that the system according to the present invention is not only limited to a transmission system comprising digital predistortion of the power amplifier and frequency-dependent phase and gain adaptation. The system can be designed in such a way that a general correction of gain as a function of amplitude, delay and frequency-dependent phase and gain is feasible.

1. An arrangement for correcting gain as a function of amplitude and of correcting frequency-dependent gain and phase for a device with a digital input signal and an analogue output signal, said arrangement comprising:
a gain correction block said gain correction block being connected at a first input for receiving an input signal, further being connected in a feedback path to an input of a power amplifier through a first output of said gain correction block and through a second input of said gain correction block to an output of said power amplifier;
said gain correction block being arranged for receiving said input signal at a third input and a gain reference signal at said second input and for correcting a first power of said input signal, relative to a second power of said output signal, to form a predistorted outgoing signal and for outputting said pre-distorted outgoing signal at said first output, said gain reference signal having a gain identical to said second power of said output signal relative to said first power of said input signal, and
a phase correction block said phase correction block being connected at a third input for receiving said input signal, said phase correction block being connected in said feedback path to said input of said power amplifier through a first output of said phase correction block, and through a second input of said phase correction block to said output of said power amplifier;
said phase correction block being arranged for receiving said input signal at a third input and a phase reference signal at said second input and for correcting said first absolute phase of said input signal, relative to said second absolute phase of said output signal, as a function of frequency to form a phase-corrected outgoing signal and for outputting at said first output said phase-corrected outgoing signal, said phase reference signal having a phase value identical to said second absolute phase of said output signal relative to said first absolute phase of said input signal,
said gain correction block and said phase correction block using a single feedback signal in said feedback path for deriving said gain reference signal and said phase reference signal, respectively.

2. The arrangement according to claim 1, wherein said input of said power amplifier comprises a digital-analogue- and up-converter, said digital-analogue- and up-converter is arranged in said feedback path between both said first outputs of said gain correction block and said phase correction block and said input of said power amplifier, and said analogue-digital converter being arranged in said feedback path between said output of said power amplifier and both said second inputs of said phase correction block and said gain correction block.

3. The arrangement according to claim 1, wherein said phase correction block is arranged for outputting at said second output a further output signal for transmission to said second input of said gain correction block as said gain reference signal.

4. The arrangement according to claim 1 wherein said gain correction block is arranged for outputting at said second output a further output signal for transmission to said second input of said phase correction block as said phase reference signal.

5. The arrangement according to claim 1, wherein said gain correction block comprises:
a digital predistortion block and an amplitude transfer estimation block,
said digital predistortion block comprising a further gain control input,
said amplitude transfer estimation block comprising a further gain control output,
said gain control output being connected to said gain control input,
said amplitude transfer estimation block being arranged for:
receiving said gain reference signal and for receiving at said third input said input signal, for comparing said input signal with said gain reference signal,
determining a gain control signal, and
outputting said gain control signal at said gain control output, and
said digital predistortion block being arranged for:
receiving said input signal at said third input and said gain control signal at said gain control input, and
correcting said first power of said input signal, relative to said second power of said output signal, as a function of amplitude, using said gain control signal.

6. The arrangement according to claim 1, wherein
said phase correction block comprises a phase adaptation block (9) and a phase estimation and correction block,
said phase adaptation block comprising a further phase control input,
said phase estimation and correction block comprising a further phase control output,
said phase control output being connected to said phase control input,
said phase estimation and correction block being arranged for:
receiving said phase reference signal and receiving at said third input said input signal, for comparing said input signal with said phase reference signal,
determining a phase control signal, and
outputting said phase control signal at said phase control output, and said phase adaptation block being arranged for:
receiving said input signal at said third input and said phase control signal at said phase control input, and
correcting said first absolute phase of said input signal, relative to said second absolute phase of said output signal, as a function of frequency, using said phase control signal.

7. The arrangement according to claim 5, wherein:
said phase adaptation block comprises a first digital Fourier transform processor (DFT), an inverse digital Fourier transform processor (IDFT), a corrector (CRT), and an adjuster (ADJ),
said digital Fourier transform processor (DFT) being connected to a first input of said corrector (CRT), said corrector (CRT) being connected at an output to an input of said inverse digital Fourier transform processor (IDFT), said adjuster (ADJ) being connected with an output to a second input of said corrector (CRT),
said digital Fourier transform processor (DFT) being arranged for:
receiving at an input said input signal and transforming said input signal as a Fourier transformed signal,
said adjuster (ADJ) being arranged for:
receiving at said phase control input said phase control signal, and at a second input a desired phase value of said phase as function of frequency and
determining an adjuster correction signal,
said corrector being arranged for:
receiving said Fourier transformed signal and said adjuster correction signal, and
determining and outputting a corrected Fourier transformed signal, and
said inverse digital Fourier transform processor (IDFT) being arranged for
receiving said corrected Fourier transformed signal and for determining and
outputting an inverse Fourier transform of said corrected Fourier transformed signal as said phase-corrected outgoing signal.

8. The arrangement according to claim 5, wherein said phase estimation and correction block comprises:
a cross-correlator (XC), a temporal processor (TP),
a second digital Fourier transform processor (DFT2), and
a spectral processor (SP),
said cross-correlator XC being connected at an output to an input of said temporal processor (TP), said temporal processor (TP) being connected at an output to an input of said second digital Fourier transform processor (DFT2), said second digital Fourier transform processor (DFT2) being connected at an output to an input of said spectral processor (SP), said spectral processor SP having said phase control output,
said cross-correlator (XC) being arranged for:
receiving on said second input said input signal and on said third input said phase reference signal,
determining, synchronising and cross-correlating said input signal and said phase reference signal into a cross-correlated signal, and
outputting said cross-correlated signal to said temporal processor (TP), said temporal processor (TP) being arranged for:
receiving said cross-correlated signal from said cross-correlator (XC),
adapting said cross-correlated signal into a modified cross-correlated signal adapted for a Fourier transform, and
outputting said modified cross-correlated signal to said second digital Fourier transform processor (DFT2),
said digital Fourier transform processor (DFT2) being arranged for:
receiving said modified cross-correlated signal,
computing a power spectrum signal from said modified cross-correlated signal, and
outputting a said power spectrum signal to said spectral processor (SP), and
said spectral processor (SP) being arranged for:
receiving said power spectrum signal,
determining at least an estimate of a phase as a function of frequency from said power spectrum signal as a phase-frequency signal, and
outputting said phase-frequency signal as said phase control signal to said phase adaptation block.

9. A method for real-time phase and gain adaptation as a function of frequency and gain adaptation as a function of amplitude of an input signal in relation to an output signal, said input signal having a first absolute phase and first power as a function of frequency, said output signal having a second absolute phase and second power as a function of frequency, said output signal, in use, being amplified relative to said input signal,
said method comprising a gain correction and a phase correction;
said gain correction comprising:
receiving said input signal and a gain reference signal from a feedback path,
correcting said first power of said input signal, relative to said second power of said output signal, into a predistorted outgoing signal, and
outputting said predistorted outgoing signal, said gain reference signal having a gain value identical to said second power of said output signal relative to said first power of said input signal, and;
said phase correction comprising:
receiving said input signal and a phase reference signal from said feedback path,
correcting said first absolute phase of said input signal, relative to said second absolute phase of said output signal, as a function of frequency into a phase-corrected outgoing signal, and
outputting said phase-corrected outgoing signal, said phase reference signal having a phase value identical to said second absolute phase of said output signal relative to said first absolute phase of said input signal,
wherein said gain correction and said phase correction are using a single feedback signal in said feedback path for deriving said gain reference signal and said phase reference signal, respectively.

10. A computer program product for correcting gain as a function of amplitude and of correcting frequency-dependent gain and phase for a device with a digital input signal and an analogue output signal, said computer program product comprising:
instructions in a computer readable media for said gain correction comprising:
instructions for receiving said input signal and a gain reference signal from a first feedback loop,
instructions for correcting said first power of said input signal, relative to said second power of said output signal, as a function of frequency into a predistorted outgoing signal, and
instructions for outputting said predistorted outgoing signal, said gain reference signal having a gain value identical to said second power of said output signal relative to said first power of said input signal, and
instructions in the computer readable media for said phase correction comprising:
instructions for receiving said input signal and a phase reference signal from said feedback path,
instructions for correcting said first absolute phase of said input signal, relative to said second absolute phase of said output signal, as a function of frequency into a phase-corrected outgoing signal, and
instructions for outputting said phase-corrected outgoing signal, said phase reference signal having a phase value identical to said second absolute phase of said output signal relative to said first absolute phase of said input signal,
wherein said gain correction and said phase correction are using a single feedback signal in said feedback path for deriving said gain reference signal and said phase reference signal, respectively.

11. (canceled)
